(19) United States
(12) Patent Application Publication
(10) Pub. No.: US 2008/0196057 A1
(43) Pub. Date: Aug. 14, 2008

(54) Apparatus, Method and System for Generating Private Personal Virtual Channels

(75) Inventors: Hong R. Li, Eindhoven (NL); Roland Peter Jan Mathijs Manders, Eindhoven (NL); Eric Moors, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,624

(22) PCT Filed: Mar. 20, 2006
(86) PCT No.: PCT/IB2006/050847

§ 371 Date: Sep. 25, 2007

(30) Foreign Application Priority Data
Mar. 31, 2005 (EP) 05102545.0

(51) Int. Cl. H04N 7/16

(52) U.S. Cl. 725/25

(57) ABSTRACT

The invention describes an apparatus, system and related method that allow a guest user to create a private personal virtual channel. The apparatus includes a user interface (8) whereby an authorized apparatus user can make an invitation to a guest user. The authorized apparatus user can also set expiry conditions (19). The apparatus can exchange guest user specific data (2, 3, 4) via user interface (8), via a data carrier (18), or via a network (17) with an equivalent apparatus in the system. The private user specific data (2, 3, 4) is concealed using a concealment unit (14). A control unit (13) works in combination with a processing unit (11) and the concealment unit (14) to conceal recorded content based upon guest user preferences and presents the concealed recorded content to the guest user alone as a continuous sequence of content via display (15) emulating a traditional broadcasted channel.

### BACKGROUND OF THE INVENTION

1. Field of the Invention

The present invention relates to an apparatus and method for creating private personal virtual channels from, for example, recorded TV programs.

2. Description of the Related Art

In accordance with the developments of highly personalised home entertainment systems using an apparatus capable of storing significant amounts of audio, video and photographic content it is essential that the privacy of the users of the apparatus be respected. In fact, US 2002/0061185 teaches that users known to such an entertainment apparatus can have their recordings protected. It is from such recordings that personal virtual channels can be constructed to present the recordings as though they originated from a broadcast television channel. Furthermore, US 2002/0061185 teaches that guest users may access such an entertainment apparatus, but with limited access rights and no privacy protection. The reduced capabilities offered to guest users and the lack of privacy protection for such users is a clear limitation of the prior art, since there are numerous circumstances where legitimate guest users should have use of an entertainment apparatus and would expect such capabilities and protection. For example, when baby-sitters are invited into the home it would be unreasonable for them not to be able to use the full apparatus capabilities within their access rights. It would be more unreasonable not to offer privacy protection of their private data. Another example would be a hotel guest making use of a hotel entertainment apparatus. Such a guest would, again, expect the full usage of the capabilities of the apparatus whilst guaranteeing privacy protection.

It is therefore desirable to provide a mechanism to enable guest users of an entertainment apparatus to fully exploit such an apparatus and simultaneously protect the privacy of such a guest user.

### BRIEF SUMMARY OF THE INVENTION

It is an object of the present invention to provide an apparatus, a method and a system to protect the privacy of guest users of a multi user entertainment apparatus.

According to a first aspect of the present invention this object is realized by providing a method for generating private personal virtual channels, the method comprising: inviting, by an authorised user, the creation of said personal virtual channel; receiving guest user specific data from a guest user; concealing from any other user said guest user specific data; and concealing recordings based on said guest user specific data.

The measure as defined in claim 0 has the advantage that the authorized user can set expiry conditions on the concealed data area of any such guest user during the invitation phase. Preferably, the expiry conditions can be related to a period of time. Advantageously the apparatus can automatically remove such a concealed data area without further authorized user intervention.

Further it is advantageous that the guest user can transport said guest user specific data over a network and does not need to perform a user initialisation and learning process. Additionally it is preferred that the guest user can carry private data on a data carrier, for example, for use when no network is available. Also in this case the guest user does not need to perform a user initialisation and learning process. It is beneficial that a host apparatus can identify the guest user, determine privacy settings required by the guest user and create a private personal virtual channel based on the preferred configuration of the guest user with no guest user interaction. It is also beneficial that any changes made by the guest user to said guest user specific data during operation of the entertainment apparatus are distributed in a suitable manner, for example by storing on said data carrier or transmitted via said network, to a second equivalent entertainment apparatus known to the guest user such that the guest user does not have to repeat identical changes when making use of said second equivalent entertainment apparatus.

According to a second aspect of the present invention the object defined above is realized by providing an apparatus as claimed in claim 9. According to a third aspect of the present invention the object defined above is further realized by providing a system as claimed in claim 10.

These and other aspects of the invention will be apparent from and elucidated with reference to the embodiments described hereinafter.

### BRIEF DESCRIPTION OF THE DRAWINGS

The invention will be described with reference to the accompanying drawings, in which:

FIG. 1 is a block diagram illustrating an embodiment of the invention;

FIG. 2 is a diagram illustrating private data areas and public data areas accessible by individual users;

FIG. 3 is a flowchart illustrating the process of guest user registration;

FIG. 4 is a flowchart illustrating the process of guest user registration with expiry conditions; and

FIG. 5 is a flowchart illustrating the process of guest user access to an embodiment of the invention.

### DETAILED DESCRIPTION OF THE INVENTION

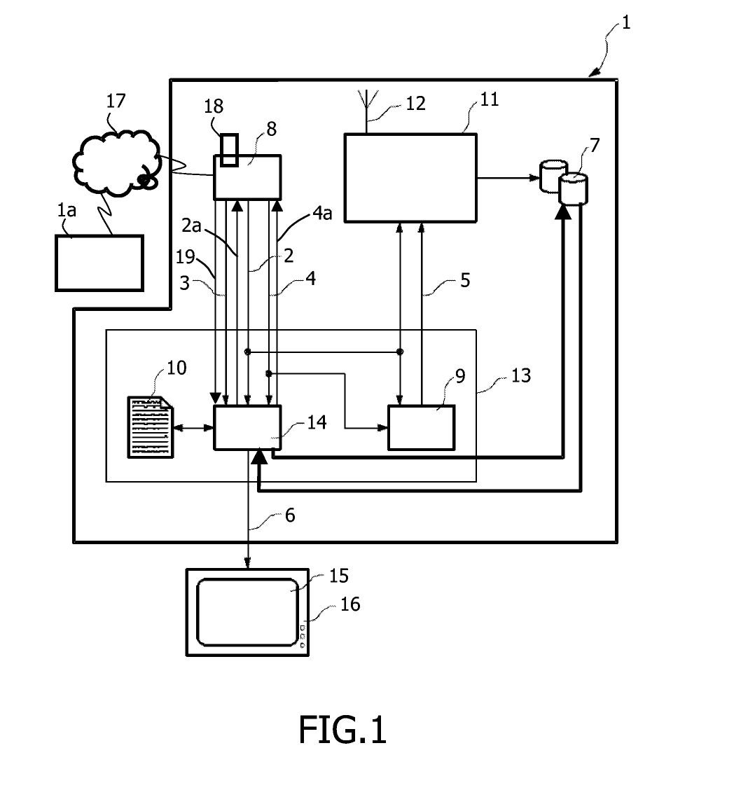

FIG. 1 shows an entertainment apparatus 1 capable of generating private personal virtual channels, in which a suitable user interface 8, which may be a keyboard, a remote control, an external input/output interface, a network interface, etc., is used by an authorized apparatus user in combination with an appropriate signal 6 displayed on a display 15 to invite a guest user to access entertainment apparatus 1. Optionally, expiry conditions 19 can also be set which can be stored in a control unit 13 as stored expiry conditions 10. The display 15 can be incorporated inside a television 16. The user interface 8 is also capable of receiving from the guest user, via a network 17 or via a data carrier 18, guest user private specific data comprising guest user virtual channel configuration data 2, a guest user identity 3 and guest user privacy settings 4.

A concealment level determination unit 14 examines the guest user virtual channel configuration data 2, the guest user identity 3 and the guest user privacy settings 4 to determine which elements of the guest user private specific data may be revealed to a second user. The second user may be any other user, for example, the second user may be another guest user or an authorised user. The control unit 13 in cooperation with the concealment level determination unit 14 is capable of creating a guest user private virtual space on a data file 7. Depending on the guest user privacy settings 4 and the guest user virtual channel configuration data 2 a recording priority determination unit 9 can determine a priority for recordings scheduled which agree with the guest user virtual channel configuration data 2. A priority for such recordings is communicated to a processing unit 11 via a priority signal 5. The processing unit 11 can record upon the data file 7 program signals received by a receiver 12 such as an antenna, cable, satellite dish or more general network whilst ensuring that such recordings are performed according to the guest user privacy settings 4. The data file 7 may be hard disk drive or any other suitable storage medium.

Optionally, the guest user may, during operation of the entertainment apparatus 1, make use of user interface 8 to update the guest user virtual channel configuration data 2 and the guest user privacy settings 4. Such changes could be stored as updated guest user virtual channel configuration data 2a and updated guest user privacy settings 4a respectively. Using data carrier 18 or network 17 the updated guest user virtual channel configuration data 2a and updated guest user privacy settings 4a can be sent to a second equivalent entertainment apparatus 1a known to the guest user such that the guest user does not then have to repeat identical changes when making use of the second equivalent entertainment apparatus 1a.

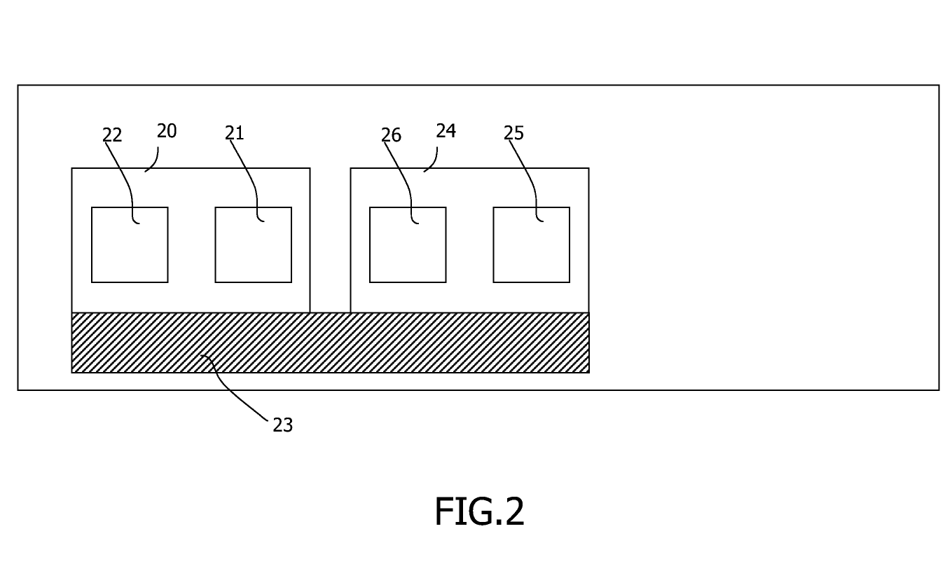

FIG. 2 is a drawing that illustrates important data areas. Referring also to FIG. 1 the important data areas are stored on the data file 7 and are accessible by individual guest users. For example, for the guest user there exists a guest user private virtual space 20 within which guest user private specific data 21 can be stored. The guest user private specific data 21 may comprise of, referring to elements in FIG. 1, a set of data describing the guest user virtual channel configuration 2, the guest user identity 3 and the guest user privacy settings 4. Also a guest user private storage space 22 can be created to store private recordings within the guest user private virtual space 20. Public content space 23 accessible to all users also intersects with the guest user private virtual space 20 thereby allowing the guest user access to both private content belonging to the guest user and public content. For a second user there exists also a private virtual space 24, private user specific data 25 and a private storage space 26. It is an important feature of the invention that only the guest user sees private data areas 20, 21 and 22 and that only the second user sees private data areas 24, 25 and 26 and that the private data areas 20, 21, 22, 24, 25 and 26 are not accessible to any other user, regardless of their status within entertainment apparatus 1.

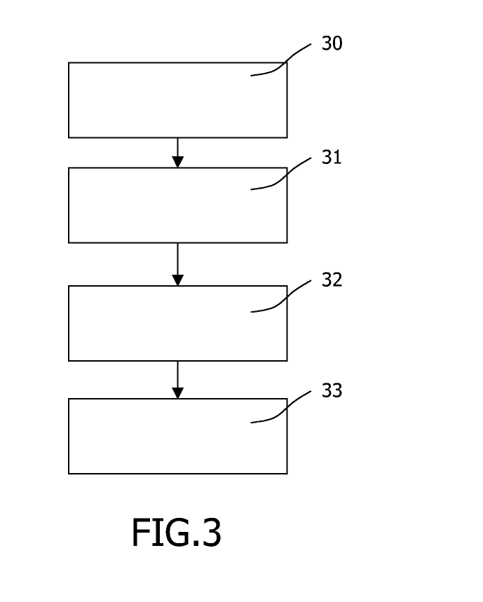

The steps taken in the method of the invention are described in FIG. 3 and for the benefit of explanation reference is made to elements of FIG. 1. In step 30 an authorized apparatus user interacts with the entertainment apparatus 1, via the user interface 8, to create an invitation for the guest user to use the entertainment apparatus 1. In step 31 the entertainment apparatus 1 receives the guest user private specific data 21. The guest user private specific data 21 may be received via the data carrier 18 connected to the user interface 8 comprising a suitable input/output connection. The data carrier 18 could be, but is not limited to, a floppy disk, CD, DVD, flash memory device etc. In a further embodiment the guest user private specific data 21 can be received via the network 17, such as the Internet, or via email. The control unit 13 creates the guest user private virtual space 20 for the guest user in step 32 according to the guest user privacy settings 4. The guest user private specific data 21 is placed within the guest user private virtual space 20 and the guest user private storage space 22 is created for future recordings to be created by the processing unit 11. In step 33 the processing unit 11 works in conjunction with the recording priority determination unit 9 via the priority signal 5 and the guest user virtual channel configuration data 2 to make recordings matching the requirements of the guest user and stores such recordings in the guest user private storage space 22. When such recordings are made a private personal virtual channel has been deemed created.

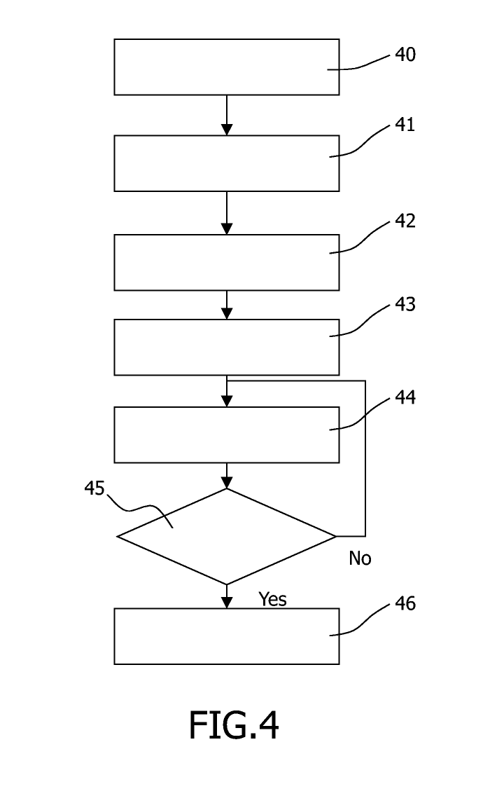

FIG. 4 presents the operation sequence flowchart of a further embodiment and again, for clarity of explanation, refers to elements of FIG. 1. In step 40 the authorized apparatus user interacts, via the user interface 8, with the entertainment apparatus 1 to create an invitation for the guest user to use the entertainment apparatus 1. In step 41 the authorized apparatus user again interacts with the entertainment apparatus 1, via the user interface 8, to specify expiry conditions 19 for the guest user private virtual space 20. An exemplary expiry condition would be a time limit. For example, assuming the guest user was a guest at a hotel with an accompanying length of stay. In such an embodiment the authorised apparatus user, for example a hotel employee, could set a suitable length of time as the stored expiry condition 10 allowing the guest user full access to the entertainment apparatus 1 and simultaneous privacy protection. Thereafter, in step 42 the entertainment apparatus 1 receives the guest user private specific data 21 as already described in detail in step 31 of FIG. 3. Step 43, which is essentially identical to step 32 of FIG. 3, involves the control unit 13 creating the guest user private virtual space 20 for the guest user. Step 44 makes use of the processing unit 11 working in conjunction with the recording priority determination unit 9 via the priority signal 5 and the guest user virtual channel configuration data 2 to make recordings matching the requirements of the guest user and storing such recordings in the guest user private storage space 22. At step 45, which is a decision point, the stored expiry conditions 10 are considered and dependant upon the result processing returns to step 44 or progresses to step 46. When at step 45 and the stored expiry conditions 10 are not met the private personal virtual channel is considered to remain operational and further private recordings may be made within the entertainment apparatus 1 by returning to step 44. However, when at step 45 and the stored expiry conditions 10 are indeed met the private personal virtual channel is deemed to have expired. Processing proceeds to step 46 where the control unit 13 of the entertainment apparatus 1 removes the guest user private specific data 21, the guest user private storage space 22, including any private recordings, and then the guest user private virtual space 20. At such a point in time all of the guest user information has been removed and is not accessible to any other user of the entertainment apparatus 1 thereby preserving completely the privacy of the guest user.

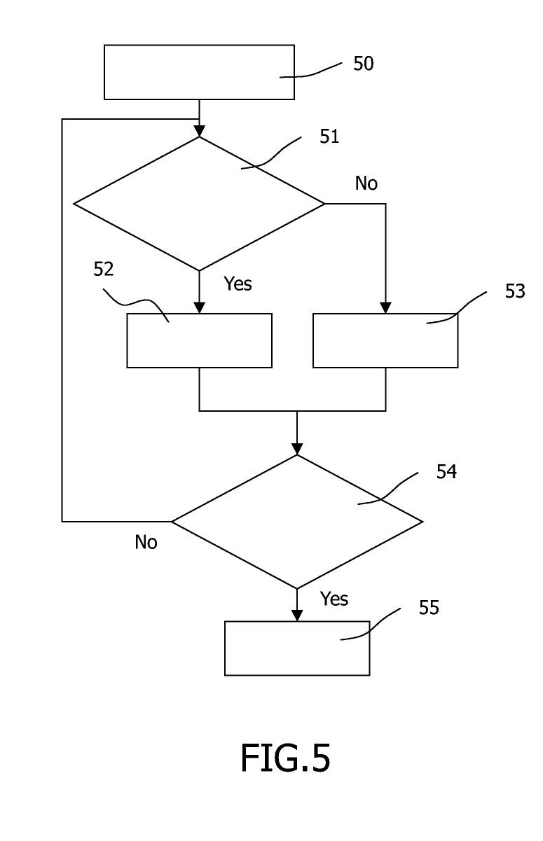

Normal viewing operation proceeds according to the flowchart in the drawings of FIG. 5. Reference is also made to some elements of FIG. 1 where this adds to the understanding of the invention. The guest user may in step 50 access the entertainment apparatus 1 by presenting the guest user identity 3 via the user interface 8. In step 51 the control unit 13 can proceed to step 52 or step 53 depending upon the existence of recordings made according to the guest user virtual channel configuration data 2, in which case the private personal virtual channel is considered to exist. If the private personal virtual channel has been configured for the guest user then in step 52 both public and private recordings are made available from data file 7 via concealment level determination unit 14 to be viewed on the display 15. Presentation on the display 15 of public and private recordings appear to the guest user sequentially without any further user interaction, as if they are from a traditional broadcast television channel, hence the term private personal virtual channels. In step 52 the guest user can also make changes to the guest user virtual channel configuration data 2, the guest user privacy settings 4 or more generally to the guest user private specific data 21 using the user interface 8 and the concealment level determination unit 14 under the control of the control unit 13. The changes to the guest user virtual channel configuration data may be stored as updated guest user virtual channel configuration data 2a and similarly changes to the guest user privacy settings 4 can be stored as updated guest user privacy settings 4a. All such changes should be preserved for situations wherein the guest user would wish to synchronize the changes with the second equivalent entertainment apparatus 1a known to the guest user. If, however, no private personal virtual channel has been configured for the guest user then in step 53 only public recordings are available for presentation on the display 15. In step 54 the entertainment apparatus 1 regularly gives the guest user the opportunity to stop being entertained. If the guest user wishes to be further entertained the control unit 13 returns to step 51. If the guest user wishes to leave the entertainment apparatus 1 then the control unit 13 proceeds to step 55. In step 55 the changes made by the guest user to the guest user private specific data 21, for example, the updated guest user virtual channel configuration data 2a and updated guest user privacy settings 4a can be stored on the data carrier 18 or sent to the network 17 such that the guest user does not have to repeat such actions again in the future on the second equivalent entertainment apparatus 1a known to the guest user. Thereafter the control unit 13 waits for the following user to access the entertainment apparatus 1 at which point step 50 becomes active.

1. A method for generating private personal virtual channels, the method comprising:
inviting (30), by an authorised user, a creation of a private personal virtual channel;
receiving (31) guest user specific data from a guest user;
concealing (32) from any other user said guest user specific data; and
concealing (33) recordings based on said guest user specific data.

2. The method of claim 1 wherein expiry conditions are set (41) on said private personal virtual channel by said authorised user.

3. The method of claim 2 wherein said expiry conditions are based on a period of time.

4. The method of claim 2 wherein said guest user specific data and said recordings are removed (46) upon validation of said expiry conditions.

5. The method of claim 1 wherein said guest user specific data are received via a network.

6. The method of claim 1 wherein said guest user specific data are collected from a data carrier device.

7. The method of claim 1 wherein said guest user specific data comprises user identity, privacy settings and virtual channel configuration data.

8. The method of claim 1 further comprising:
performing modifications (52) on said guest user specific data during guest user operation of a first apparatus capable of generating private personal virtual channels; and
sending said modifications (55) to an equivalent second apparatus capable of generating private personal virtual channels.

9. An apparatus (1) for generating private personal virtual channels comprising:
means for inviting (8), by an authorised user, a creation of a private personal virtual channel;
means for receiving (8) guest user specific data from a guest user;
means for concealing (14) from any other user said guest user specific data; and
means for concealing (14) recordings based on said guest user specific data.

10. A system for generating private personal virtual channels comprising:
means for receiving (8), on a first apparatus capable of generating private personal virtual channels, guest user specific data from a guest user;
means for concealing (14), on said first apparatus, from any other user said guest user specific data;
means for performing modifications (8) on said guest user specific data during guest user operation of said first apparatus; and
means for sending said modifications (8) from said first apparatus to an equivalent second apparatus capable of generating private personal virtual channels.

11. A computer program that, when executed on a processing system, causes the processing system to
invite (30), by an authorised user, a creation of a private personal virtual channel;
receive (31) guest user specific data from a guest user;
conceal (32) from any other user said guest user specific data; and
conceal (33) recordings based on said guest user specific data.
